(19) United States
(12) Patent Application Publication
(10) Pub. No.: US 2006/0056645 A1
(43) Pub. Date: Mar. 16, 2006

(54) Construction of certain continuous signals from digital samples of a given signal

(76) Inventor: David E. Wallis, Glendale, CA (US)

Correspondence Address: ROBERT J. SCHAAP;Suite 188, 21241 Ventura Boulevard, Woodland Hills, CA, 91364, US

(21) Appl. No.: 10/932,610

(22) Filed: Sep. 1, 2004

(51) Int. Cl. H04R 1/40

(52) U.S. Cl. 381/97

(57) ABSTRACT

A method for the construction of useful signals, Q (the Hilbert transform) and I′ (the derivative) from a (Nyquist) sequence of samples of I, a given signal, which signal may or may not be available in its continuous, band-limited form. The signal Q is constructed using the continuous function

$$\frac{cos x - 1}{x}$$

in place of the previously and well-known function

$$\frac{sin x}{x}$$

used to reconstruct I from (Nyquist) samples of I. It is also possible to substitute the continuous function

$$\frac{cos x - \frac{sin x}{x}}{x}$$

for

$$\frac{sin x}{x}$$

to produce the derivative I′. These are particularly advantageous with audio CD players and the like in which the numerical data stream is fed into a construction or reconstruction process using a digital to analog converter.

### BACKGROUND OF THE INVENTION

1. Field of the Invention

This invention relates in general to a unique method of constructing certain continuous signals from discrete samples of a given signal. This is particularly advantageous with audio CD players and the like in which the numerical data stream is reconstructed into continuous functions by the player using a digital to analog converter.

2. Brief Description of Related Art

Audio CD players, including DVD players which generate audio signals, and the like all rely upon the well-known interpolation process which uses a summation of weighted, time-shifted

$$\frac{sin x}{x}$$

functions. An original signal I can be represented by a sequence of numerical samples of the function's values at regular sampling intervals. These numerical samples are, essentially, digital samples. The player reconstructs a representation of the continuous function I by this interpolation process using the time-shifted

$$\frac{sin x}{x}$$

functions. There is a weighted

$$\frac{sin x}{x}$$

function for each sample.

Inasmuch as the

$$\frac{sin x}{x}$$

sample function is a continuous function, the sum of these various samples would also be continuous. The prior art and, in particular, the prior art dealing with audio CDs and audio CD players, uses digital to analog (D-A) conversion in which the reconstruction is performed in that conversion function. Notwithstanding, the exact means used to perform the reconstruction always uses the property of forming a sum of

$$\frac{sin x}{x}$$

functions and outputs these functions as the reconstructed continuous function I.

A search of the prior art reveals no functions other than

$$\frac{sin x}{x} ,$$

weighted by the sample values of I, used for any purpose of constructing continuous functions.

### OBJECTS OF THE INVENTION

It is, therefore, one of the primary objects of the present invention to provide a method of constructing certain useful continuous signals, other than I itself, from samples of a given original signal I and, particularly, digital samples of I.

It is another object of the present invention to provide a method of constructing continuous derivatives of that given continuous signal I and also constructing continuous Hilbert integral transforms of that original signal I.

It is a further object of the present invention to provide the two continuous functions

$$\frac{cos x - 1}{x} and \frac{cos x - \frac{sin x}{x}}{x}$$

to be applied in lieu of

$$\frac{sin x}{x} .$$

It is also an object of the present invention to provide a method of generating a continuous signal Q from samples of a given signal I which utilizes the Hilbert transform of

$$\frac{sin x}{x} .$$

It is also an object of the present invention to provide a method of generating a continuous signal I′ from samples of a given signal I which utilizes the derivative of

$$\frac{sin x}{x} .$$

With the above and other objects in view, my invention resides in the novel features and form and the fact that samples of I can be used to generate useful continuous signals other than I itself.

### SUMMARY OF THE INVENTION

More specifically, the present invention teaches that other useful functions, other than the original continuous signal function I, can be constructed from samples of that given original signal I and also that the derivative I′ of I and the Hilbert integral transform of I, namely “Q”, can be computed from these samples of I. In this respect, other functions, such as higher order derivatives and other integral transforms are contemplated within and could be used in the scope of the invention.

In the invention, the D-A converter, which allows the substitution of the continuous function

$$\frac{cos x - 1}{x}$$

for the original function

$$\frac{sin x}{x}$$

can produce the continuous signal Q. It is also possible to substitute the continuous derivative function, namely

$$\frac{cos x - \frac{sin x}{x}}{x}$$

for

$$\frac{sin x}{x}$$

thereby to produce the continuous derivative I′. All of this is accomplished in the D-A converter which is used in the audio equipment. In effect, the conversion relies upon the linearity (with respect to summation) of certain operations of the differential and integral calculus in order to achieve the constructions Q and I′. The order of summation and the integral/differential operations can be interchanged. In other words, if the original function of I can be constructed as a sum of weighted

$$\frac{sin x}{x}$$

functions, then the Hilbert transform Q can be constructed as a sum of weighted functions, each of which is the Hilbert transform of

$$\frac{sin x}{x} .$$

Moreover, the derivative I′ can be constructed as a sum of weighted functions, each of which is the derivative of

$$\frac{sin x}{x} .$$

In short, the principle of the invention relies on the use of a transversal filter and its coefficients arranged in accordance with the function

$$\frac{cos x - 1}{x}$$

to obtain Q, and with the function

$$\frac{cos x - \frac{sin x}{x}}{x}$$

to obtain I′. As stated above, the coefficients of the transversal filter in the prior art are arranged in accordance with

$$\frac{sin x}{x} .$$

In like manner, the functions

$$\frac{cos x - 1}{x} and \frac{cos x - \frac{sin x}{x}}{x}$$

are substituted for the standard function

$$\frac{sin}{x}$$

in order to produce, respectively, the Hilbert transform and the derivative of the original signal I.

In essence, the samples of the original signal I can be used to generate two continuous functions at the D-A output, one of which is the Hilbert transform of the function I and the other of which is the derivative of the function I. The samples of I are passed through the transversal filter in the D-A converter which allows for the finite impulse response to be implemented in a digital signal processing (DSP) chip. At present, this is the only economical way to implement complicated functions of this type. Thus, one of the important aspects of this invention is that the layout is similar to that of a conventional audio player. The main difference is that the audio player presently uses the

$$\frac{sin x}{x}$$

function, whereas in this invention the function

$$\frac{cos x - 1}{x}$$

creates the continuous Hilbert transform of the original function I. Alternatively, the function

$$\frac{cos x - \frac{sin x}{x}}{x}$$

is used to create the derivative of that original continuous function I.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a graphical illustration of a reference sine wave, sin x, at unit frequency, where unit frequency is the Nyquist frequency, i.e., the highest frequency that can be contained in the original band-limited function I, and where the Nyquist samples of the function I are assumed to have been taken at the zero crossings of sin x, i.e., every π radians;

FIG. 2 is a graphical illustration of the waveform

$$\frac{sin x}{x}$$

at the same scale as FIG. 1;

FIG. 3a is a graphical illustration of the function

$$\frac{cos x - 1}{x}$$

to the same scale as FIGS. 1 and 2, which is the Hilbert transform of

$$\frac{sin x}{x} ; and$$

FIG. 3b is a graphical illustration, somewhat similar to FIG. 3a, of the function

$$\frac{cos x - \frac{sin x}{x}}{x}$$

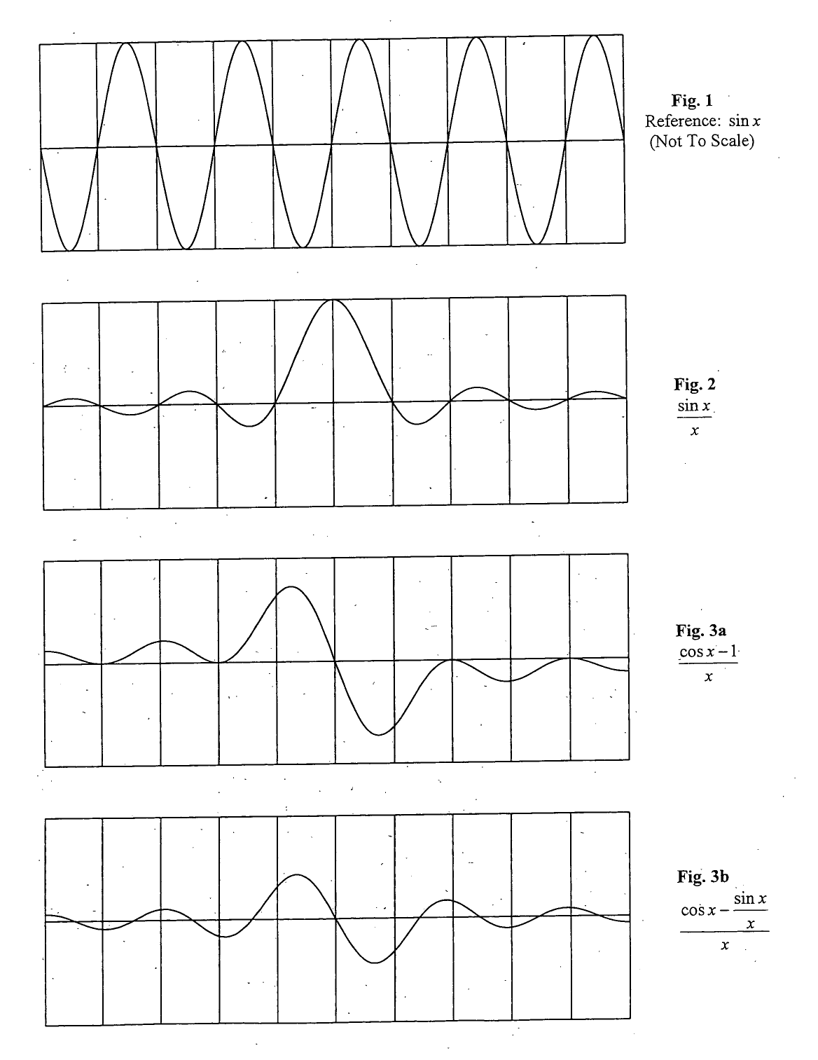

to the same scale as FIGS. 1, 2 and 3a, which is the derivative of

$$\frac{sin x}{x} .$$

### DETAILED DESCRIPTION OF A PREFERRED EMBODIMENT

Referring now in more detail and by reference characters to the drawings, the use of the invention may best be illustrated by reference to FIGS. 1 through 4. It can be observed in FIG. 1 that this graph is only for reference and, generally, is a plot of the trigonometric function sin x. Ths amplitude is unity and the spacing of the marked abscissas is π radians. These amplitudes reach zero at every half period which constitutes a zero crossing. The zero crossings effectively define the time instants where sampling would have occurred. In essence, this defines the samples of the function I. The sin x waveform of FIG. 1 uses the unit frequency as the Nyquist frequency, which is the maximum frequency that can be contained in the band limited function I. Obviously, the minimum frequency would be zero.

FIG. 2 is also for reference purposes and illustrates a plot of

$$\frac{sin x}{x}$$

which is the waveform used in the prior art devices. This is the interpolating function for reconstructing the band limited function I from a sequence of its samples and without a loss of generality when the Nyquist frequency is unity.

Initially, it may be noted that only the waveforms 3a and 3b are used in the implementation of the present invention. Note further that the amplitude range, and also the attenuation forward and backward in the argument (abscissa) x, are roughly comparable to those of

$$\frac{sin x}{x}$$

used in players.

FIG. 3a illustrates a waveform used to construct the continuous band-limited Hilbert integral transform Q of the function I from a sample sequence of I. In other words, the Hilbert integral transform uses the function

$$\frac{cos x - 1}{x}$$

for constructing that transform Q. As indicated in this case, Q is derived from the sample sequence of that signal I. FIG. 3b illustrates a waveform of the derivative of

$$\frac{sin x}{x} ,$$

namely the waveform of

$$\frac{cos x - \frac{sin x}{x}}{x}$$

which is used to construct the continuous band-limited first derivative I′ of the original function I from the sample sequence of the function I.

The function Q which is the Hilbert transform of the original continuous signal I has the property that all of its frequency components are 90 degrees shifted in phase (the phase shift is 90 degrees leading) relative to the corresponding frequency components contained in that original signal I without any change in the amplitudes of those components.

The method of the invention in constructing the continuous band-limited function I can incorporate the use of sampling means to obtain the samples of the original continuous function I at regular sampling intervals. In this way, the method can be used as a building block in other systems. For example, the method can be embedded in a larger system to implement any one or more of the following activities:
a) AM-SSB by the “phasing method”;
b) phase equalizers;
c) phase detectors; and
d) audio “special effects” and the like, requiring the 90° phase shift property of the Hilbert transform.

The method of the invention can also be used as building blocks, e.g. it can be embedded in a system to implement the “equalizer” functions used in other frequency range applications. Specifically, those other frequency ranges may be higher or lower than audio frequency, such as those of or higher than radio frequency.

There is some inconsistency in the usage of the term “quadrature signal” in the prior art. But, Q, as used in the present application, nevertheless designates a signal which is in quadrature with the given I, and computed from the samples of I. As stated, the present invention also computes a derivative I′ from the samples of I. In the case of I′, the phases of the frequency components of I are all shifted 90 degrees leading, but the amplitudes of the components are not preserved.

In substance, the function

$$\frac{sin x}{x}$$

is essentially the reconstruction function and

$$\frac{cos x - 1}{x}$$

is the Hilbert transform of that reconstruction function yielding Q, and

$$\frac{cos x - \frac{sin x}{x}}{x}$$

is the derivative of that reconstruction function, yielding I′. The exact use of these functions in accordance with the invention for reconstructing the signal is essentially the same as the

$$\frac{sin x}{x}$$

function used in a conventional audio player. It is actually possible and even highly desirable to use

$$\frac{cos x - 1}{x}$$

to construct the continuous band-limited function Q. The same holds true to use

$$\frac{cos x - \frac{sin x}{x}}{x}$$

to construct the continuous band-limited derivative I′ from the sample sequence of I. The actual solution can be accomplished by a circuitry of the types illustrated in Pohlmann, K. C., The Compact Disk Handbook, 2^{nd} Ed.

The method of the invention in constructing the continuous band-limited function I′ can also incorporate the use of sampling means to obtain the samples of the original continuous function I at regular sampling intervals. In this way, the method can be used as a building block in other systems with respect to I′. For example, the method can be embedded in a larger system to implement audio “special effects” and audio equalizer and pre-emphasis activities, that is, special effects requiring differentiation of the original signal I. The method of the invention using I′ can also be used as building blocks.

Thus, there has been illustrated and described a unique and novel method, in the case where a weighted sum of

$$\frac{sin x}{x}$$

functions would reproduce a continuous I function, wherein substituting and using in place of

$$\frac{sin x}{x}$$

the continuous function

$$\frac{cos x - 1}{x}$$

produces the signal Q or the derivative

$$\frac{cos x - \frac{sin x}{x}}{x}$$

produces the signal I′, all with high fidelity.

The present invention thereby fulfills all of the objects and advantages which have been sought. It should be understood that many changes, modifications, variations and other uses and applications which will become apparent to those skilled in the art after considering the specification and the accompanying drawings. As simple examples, other integral transforms and also higher-order derivatives could also be potentially created using the concepts of the present invention. Therefore, any and all such changes, modifications, variations and other uses and applications which do not depart from the spirit and scope of the invention are deemed to be covered by the invention.

Having thus described the invention, what I desire to claim and secure by Letters Patent is:

1. A method for constructing a Hilbert transform Q of an original continuous band-limited function I from Nyquist samples of I in accordance with the following:
a) reading a series of Nyquist samples of an original continuous function I;
b) providing an interpolation process comprising time shifted
$$\frac{cos x - 1}{x}$$
functions, each weighted by sample values of these samples;
c) summing all of the time shifted, weighted
$$\frac{cos x - 1}{x}$$
functions;
d) constructing the continuous band-limited function Q from the summed, weighted
$$\frac{cos x - 1}{x}$$
functions; and
e) outputting the constructed continuous Q function.

2. The method of constructing the continuous band-limited function Q of claim 1 further characterized in that said method incorporates the use of sampling means to obtain the samples of the original continuous function I at regular sampling intervals.

3. The method of claim 1 further characterized in that the method is embedded in a system to implement any one of the following activities:
a) AM-SSB by the phasing method;
b) phase equalizer;
c) phase detectors; and
d) audio special effects requiring the 90° phase shift property of the Hilbert transform.

4. The method of claim 3 further characterized in that the method is embedded in a system operating at audio frequencies and in other frequency range applications lower than and higher than audio frequency.

5. The method of claim 2 further characterized in that the method is embedded in a system to implement any one of the following activities:
a) AM-SSB by the phasing method;
b) phase equalizer;
c) phase detectors; and
d) audio special effects requiring the 90° phase shift property of the Hilbert transform.

6. The method of claim 5 further characterized in that the method is embedded in a system operating at audio frequencies and in other frequency range applications lower than and higher than audio frequency.

7. A method for constructing a derivative I′ of an original continuous band-limited function I from Nyquist samples of I in accordance with the following:
a) reading a series of Nyquist samples of an original continuous function I;
b) providing an interpolation process comprising of time shifted
$$\frac{cos x - \frac{sin x}{x}}{x} ,$$
each weighted by sample values of these samples;
c) summing all of the time shifted, weighted
$$\frac{cos x - \frac{sin x}{x}}{x}$$
functions;
d) constructing the continuous band-limited function I′ from the summed, weighted
$$\frac{cos x - \frac{sin x}{x}}{x}$$
functions; and
e) outputting the constructed continuous I′ function.

8. The method of constructing the continuous band-limited function I′ of claim 7 further characterized in that said method incorporates the use of sampling means to obtain the samples of the original continuous function I at regular sampling intervals.

9. The method of claim 7 further characterized in that the method is embedded in a system to implement any one or more of audio special effects and audio equalizer and pre-emphasis activities.

10. The method of claim 7 further characterized in that the method is embedded in a system operating at audio frequencies and in other frequency range applications lower than and higher than audio frequency.

11. The method of claim 8 further characterized in that the method is embedded in a system to implement any one or more of audio special effects and audio equalizer and pre-emphasis activities.

12. The method of claim 8 further characterized in that the method is embedded in a system operating at audio frequencies and in other frequency range applications lower and higher than audio frequency.
